(19) United States
(12) Patent Application Publication
(10) Pub. No.: US 2024/0258663 A1
(43) Pub. Date: Aug. 1, 2024

(54) Power Storage Cell

(71) Applicant: TOYOTA JIDOSHA KABUSHIKI KAISHA, Toyota-shi Aichi-ken (JP)

(72) Inventors: Atsushi SUGIHARA, Toyota-shi Aichi-ken (JP); Seigo FUJISHIMA, Miyoshi-shi Aichi-ken (JP); Takeru HARA, Toyota-shiAichi-ken (JP); Jun IZUMI, Toyota-shi Aichi-ken (JP); Tsuyoshi KANEKO, Nisshin-shi Aichi-ken (JP)

(73) Assignee: TOYOTA JIDOSHA KABUSHIKI KAISHA, Toyota-shi Aichi-ken (JP)

(21) Appl. No.: 18/420,302

(22) Filed: Jan. 23, 2024

(30) Foreign Application Priority Data
Jan. 27, 2023 (JP) 2023-010825

(51) Int. Cl. H01M 50/583; H01M 10/42; H01M 50/103; H01M 50/474; H01M 50/477; H01M 50/489

(52) U.S. Cl. CPC H01M 50/583; H01M 10/4214; H01M 50/103; H01M 50/474; H01M 50/477; H01M 50/489; H01M 2200/103

(57) ABSTRACT

A power storage cell includes a cell case and an electrode assembly. The cell case houses the electrode assembly. The cell case includes a top wall, a peripheral wall, and a bottom wall. The top wall faces the bottom wall. The peripheral wall connects the top wall and the bottom wall. The top wall is provided with an electrode terminal. A current path that electrically connects the electrode terminal and the electrode assembly is formed in the cell case. The current path includes a fuse portion. The power storage cell further includes at least one of a thermal expansion member and a thermal contraction member. The thermal expansion member is disposed between the top wall and the electrode assembly. The thermal contraction member is disposed between the electrode assembly and at least one of the peripheral wall and the bottom wall. The thermal contraction member supports the electrode assembly.

### CROSS REFERENCE TO RELATED APPLICATIONS

This nonprovisional application is based on Japanese Patent Application No. 2023-010825 filed on Jan. 27, 2023 with the Japan Patent Office, the entire contents of which are hereby incorporated by reference.

### BACKGROUND

### Field

The present disclosure relates to a power storage cell.

### Description of the Background Art

Japanese Patent Application Laid-Open No. 2015-103521 discloses a fuse portion disposed between a terminal bonding portion and an electrode bonding portion.

### SUMMARY

It has been proposed to provide a fuse portion in a cell case. When an overcurrent flows through a circuit in the cell case, the fuse portion is disconnected, with the result that the circuit can be interrupted. However, vibration may be applied to the power storage cell after the circuit is interrupted. The fuse portion may be recombined by the vibration. That is, the circuit may be recovered. Therefore, it is an object of the present disclosure to inhibit the fuse portion from being recombined.

Hereinafter, the technical configurations, functions and effects of the present disclosure will be described. However, mechanisms of functions in the present specification include presumptions. The mechanisms of functions do not limit the technical scope of the present disclosure.

1. A power storage cell includes a cell case and an electrode assembly. The cell case houses the electrode assembly. The cell case includes a top wall, a peripheral wall, and a bottom wall. The top wall faces the bottom wall. The peripheral wall connects the top wall and the bottom wall.

The top wall is provided with an electrode terminal. A current path that electrically connects the electrode terminal and the electrode assembly is formed in the cell case. The current path includes a fuse portion.

The power storage cell further includes at least one of a thermal expansion member and a thermal contraction member. The thermal expansion member is disposed between the top wall and the electrode assembly. The thermal contraction member is disposed between the electrode assembly and at least one of the peripheral wall and the bottom wall. The thermal contraction member supports the electrode assembly.

In the present disclosure, the thermal expansion member can be disposed in the cell case. The thermal expansion member exhibits positive thermal expansion. When an overcurrent flows in the cell case, a temperature in the cell case can be increased. The thermal expansion member can be expanded to cause the thermal expansion member to press the electrode assembly. Thus, external force is applied to the fuse portion. Therefore, disconnection of the fuse portion is expected to be promoted. Further, the expanded thermal expansion member can restrain the electrode assembly. Therefore, portions of the disconnected fuse portion can be inhibited from coming close to each other again at the time of vibration. That is, the fuse portion can be inhibited from being recombined.

In the present disclosure, the thermal contraction member can also be disposed in the cell case. The thermal contraction member exhibits negative thermal expansion. The thermal contraction member supports the electrode assembly. When an overcurrent flows in the cell case, a temperature in the cell case can be increased. The thermal contraction member is contracted to cause the electrode assembly to lose its support from the thermal contraction member. Part of the self-weight of the electrode assembly is distributed to the fuse portion, with the result that it is expected to promote disconnection of the fuse portion. Further, the self-weight of the electrode assembly can restrain the electrode assembly. Therefore, portions of the disconnected fuse portion can be inhibited from coming close to each other again at the time of vibration. That is, the fuse portion can be inhibited from being recombined.

2. In the power storage cell according to “1”, for example, the power storage cell may be configured such that at least one of expansion of the thermal expansion member and contraction of the thermal contraction member may increase a distance between the top wall and the electrode assembly.

For example, since the distance between the top wall and the electrode assembly is increased, a distance of an interruption portion is expected to be increased. Since the distance of the interruption portion is increased, the fuse portion can be further inhibited from being recombined.

3. In the power storage cell according to “1” or “2”, the electrode assembly may be suspended from the top wall.

Since the electrode assembly is suspended, the self-weight of the electrode assembly can act on the fuse portion. It is expected that the disconnection of the fuse portion is promoted by the self-weight of the electrode assembly.

4. In the power storage cell according to any one of “1” to “3”, the electrode assembly may include an electrode tab. The electrode tab may be provided with the fuse portion.

The self-weight of the electrode assembly tends to be likely to be concentrated on the electrode tab. Since the electrode tab is provided with the fuse portion, the disconnection of the fuse portion is expected to be promoted.

5. The power storage cell according to any one of “1” to “4” may include both the thermal expansion member and the thermal contraction member.

With a synergy of the thermal expansion member and the thermal contraction member, it is expected to further inhibit the fuse portion from being recombined.

An embodiment (hereinafter, also simply referred to as “the present embodiment”) of the present disclosure will be described below. However, the present embodiment does not limit the technical scope of the present disclosure. The present embodiment is illustrative in any respect. The present embodiment is non-restrictive. The technical scope of the present technology includes any modifications within the scope and meaning equivalent to the terms of the claims. For example, it is initially expected to extract freely configurations from the present embodiment and combine them freely.

The foregoing and other objects, features, and aspects of the present disclosure will become more apparent from the following detailed description of the present disclosure when taken in conjunction with the accompanying drawings.

### BRIEF DESCRIPTION OF THE DRAWINGS

FIG. 1 is a schematic perspective view of a power storage cell according to the present embodiment.

FIG. 2 is an exploded perspective view of the power storage cell according to the present embodiment.

FIG. 3 is a schematic cross-sectional view of the power storage cell according to the present embodiment.

FIG. 4 is a conceptual diagram showing an example of arrangement of thermal expansion members in the present embodiment.

FIG. 5 is a conceptual diagram showing a first disconnection example of a fuse portion.

FIG. 6 is a conceptual diagram showing a second disconnection example of the fuse portion.

FIG. 7 is a conceptual diagram showing a third disconnection example of the fuse portion.

FIG. 8 is a conceptual diagram showing a first arrangement example of the thermal contraction member in the present embodiment.

FIG. 9 is a conceptual diagram showing a second arrangement example of the thermal contraction member in the present embodiment.

FIG. 10 is a conceptual diagram showing an example of arrangement of a thermal expansion member and a thermal contraction member in the present embodiment.

### DESCRIPTION OF THE EMBODIMENTS

In this embodiment, geometric terms (e.g., “parallel”, “vertical”, “orthogonal”, etc.) should not be construed in a strict sense. For example, “parallel” may be somewhat offset from “parallel” in a strict sense. Geometric terms may include, for example, tolerances, errors, etc., in design, operation, manufacturing, etc. The dimensional relationship in each figure may not match the actual dimensional relationship. Dimensional relationships (length, width, thickness, etc.) in each figure may have been changed to assist the reader in understanding. Further, some components may be omitted. In the drawings, the same or corresponding members may be denoted by the same reference numerals.

For example, “at least one of A and B” includes “A or B” and “A and B”. “At least one of A and B” may also be referred to as “A and/or B”.

The “electrode” is a generic term for a positive electrode and a negative electrode. The electrode may be referred to as, for example, “at least one of a positive electrode and a negative electrode”. The electrode terminal may be referred to as, for example, “at least one of a positive electrode terminal and a negative electrode terminal”. The electrode tab may be referred to as, for example, “at least one of the positive electrode tab and the negative electrode tab”.

### 1. POWER STORAGE CELL

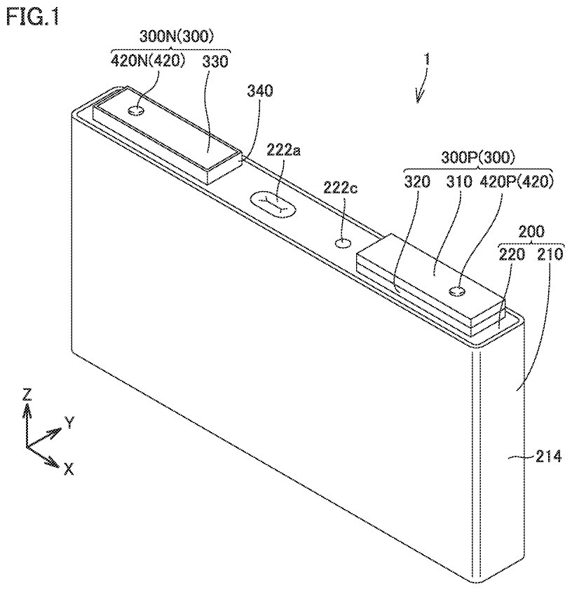

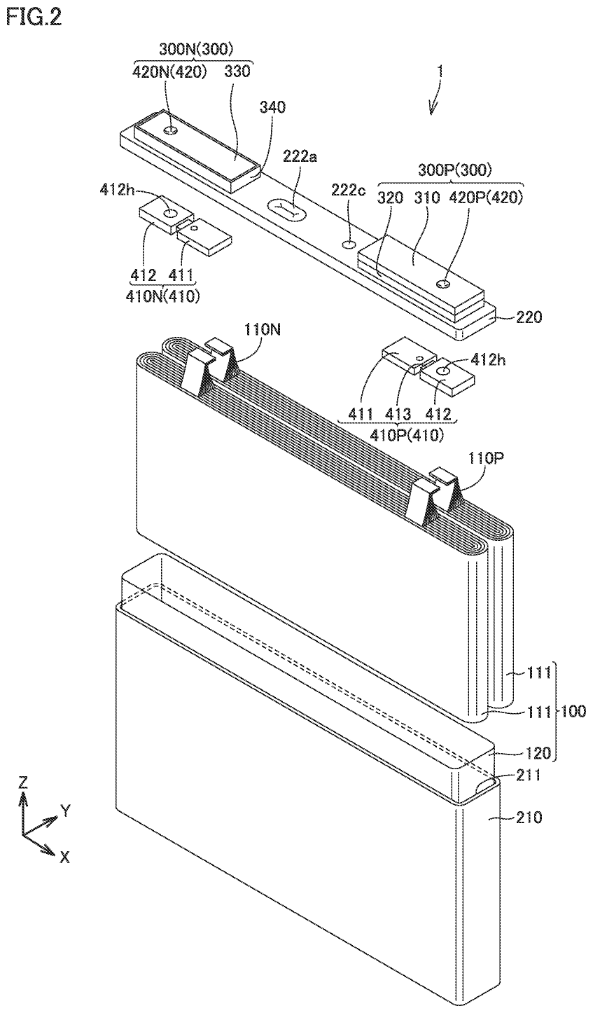

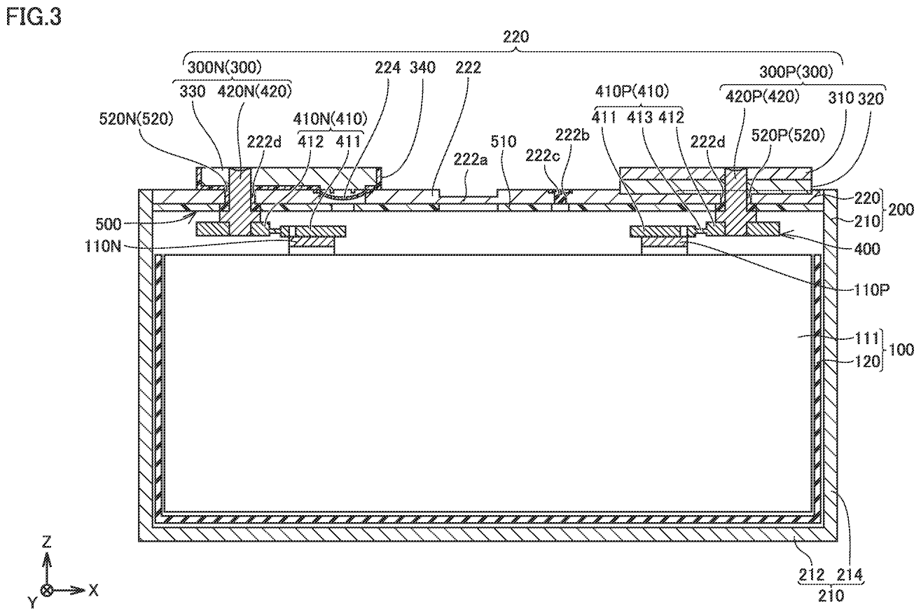

FIG. 1 is a schematic perspective view of a power storage cell according to the present embodiment. FIG. 2 is an exploded perspective view of the power storage cell according to the present embodiment. FIG. 3 is a schematic cross-sectional view of the power storage cell according to the present embodiment. The power storage cell 1 includes a cell case 200 and an electrode assembly 100.

### 2. ELECTRODE ASSEMBLY

The electrode assembly 100 may include, for example, a plurality of unit electrode assemblies 111 and an insulating film 120 (see FIG. 2). The electrode assembly 100 may include, for example, two to four unit electrode assemblies 111. Each of the plurality of unit electrode assemblies 111 may have, for example, the same structure. Each of the plurality of unit electrode assemblies 111 may have a different structure, for example.

The unit electrode assembly 111 may have any structure. The unit electrode assembly 111 may be, for example, a stacked type. The unit electrode assembly 111 may be, for example, a wound type. The unit electrode assembly 111 may include, for example, a positive electrode sheet, a separator, and a negative electrode sheet. Each of the positive electrode sheet, the negative electrode sheet, and the separator may have, for example, a belt-like planar shape.

Each of the plurality of unit electrode assemblies 111 may include a plurality of positive electrode tabs 110P and a plurality of negative electrode tabs 110N. That is, the electrode assembly 100 may include electrode tabs.

The positive electrode sheet may include, for example, a metal foil and a positive electrode composite material layer. The positive electrode composite material layer may be disposed, for example, on the surface of the metal foil. For example, the positive electrode composite material layer may be formed by coating the surface of the metal foil with the positive electrode slurry. A non-coated portion may be formed on the upper long side of the metal foil. No positive electrode composite material layer was formed in the non-coated portion. In the non-coated portion, the metal foil is exposed. For example, a plurality of positive electrode tabs 110P may be bonded to the non-coated portion. The plurality of positive electrode tabs 110P may be spaced apart from each other.

The negative electrode sheet may include, for example, a metal foil and a negative electrode composite material layer. The negative electrode composite material layer may be disposed, for example, on the surface of the metal foil. For example, the negative electrode composite material layer may be formed by coating the surface of the metal foil with the negative electrode slurry. A non-coated portion may be formed on the upper long side of the metal foil. No negative electrode composite material layer was formed in the non-coated portion. In the non-coated portion, the metal foil is exposed. For example, a plurality of negative electrode tabs 110N may be bonded to the non-coated portion. The plurality of negative electrode tabs 110N may be spaced apart from each other.

For example, the insulating film 120 may collectively cover the peripheral surface and the bottom surface of the plurality of unit electrode assemblies 111 (see FIG. 2).

### 3. CELL CASE

The cell case 200 houses the electrode assembly 100. The cell case 200 also houses an electrolyte solution (not shown). The cell case 200 is sealed. The cell case 200 includes a case body 210 and a lid 220.

The case body 210 has an opening 211 that opens upward (see FIG. 2). The case body 210 may be made of metal, for example. The case body 210 may include, for example, Al or the like. The case body 210 includes a peripheral wall 214 and a bottom wall 212 (see FIG. 3). That is, the cell case 200 includes a peripheral wall 214 and a bottom wall 212. The bottom wall 212 may be rectangular and flat, for example. The peripheral wall 214 rises from the bottom wall 212. The peripheral wall 214 may be, for example, a quadrangular tube. The dimension of the peripheral wall 214 in the width direction (X-axis direction) may be larger than the dimension of the peripheral wall 214 in the thickness direction (Y-axis direction), for example. The dimension of the peripheral wall 214 in the height direction (Z-axis direction) may be larger than the dimension of the peripheral wall 214 in the thickness direction, for example. The height direction may be, for example, along the vertical direction. The height direction may be, for example, parallel to the vertical direction.

The lid 220 includes a top wall 222. That is, the cell case 200 includes a top wall 222. The top wall 222 closes the opening 211. The top wall 222 is joined to the peripheral wall 214. That is, the peripheral wall 214 connects the top wall 222 and the bottom wall 212. For example, the top wall 222 may be bonded to the peripheral wall 214 by laser welding. The lid 220 may have, for example, a flat plate shape. The lid 220 may be made of metal, for example. The lid 220 may include, for example, Al or the like. The top wall 222 is provided with a positive electrode terminal 300P, a positive electrode terminal block 320, a top wall 222, an insulating gasket 520, and a negative electrode terminal 300N (see FIG. 3). That is, the electrode terminal 300 is provided on the top wall 222. Further, for example, the pressure release valve 222a, the liquid injection hole 222b, the sealing member 222c, the through hole 222d, and the like may be provided in the top wall 222. The electrode assembly 100 is connected to an electrode terminal 300. The electrode assembly 100 may be suspended from the top wall 222.

### 4. CURRENT PATH

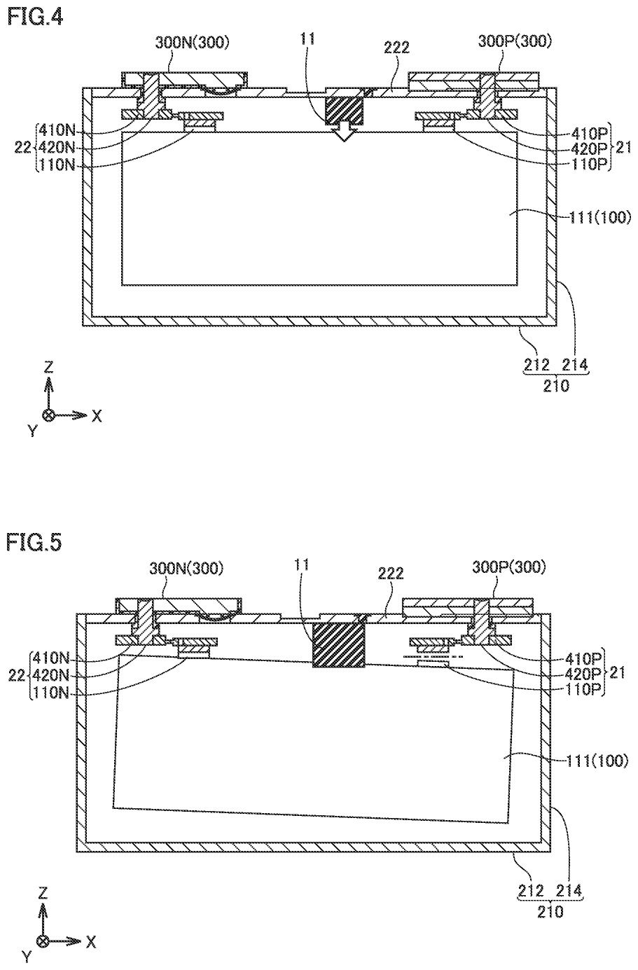

The power storage cell 1 may include a coupling member 400. The coupling member 400 is electrically conductive. The coupling member 400 includes a current collector plate 410. The current collector plate 410 is connected to a plurality of electrode tabs. The current collector plate 410 includes a positive electrode current collector plate 410P and a negative electrode current collector plate 410N. The positive electrode current collector plate 410P connects a plurality of positive electrode tabs 110P and positive electrode coupling pins 420P. That is, the coupling member 400 electrically connects the electrode terminal 300 and the electrode assembly 100. In the cell case 200, the positive electrode coupling pin 420P, the positive electrode current collector plate 410P, and the positive electrode tab 110P form a “first current path 21” (see FIG. 4).

The positive electrode terminal 300P includes a positive electrode terminal plate 310, a positive electrode terminal block 320, and a positive electrode coupling pin 420P (see FIG. 3). The positive electrode terminal plate 310 may have, for example, a rectangular parallelepiped outer shape. The positive electrode terminal plate 310 may be made of metal, for example. The positive electrode terminal plate 310 may contain, for example, Al or the like. The positive electrode terminal block 320 may be made of metal, for example. The positive electrode terminal block 320 may have a material different from that of the positive electrode terminal plate 310, for example. The positive electrode terminal block 320 may have a lower melting point than the positive electrode terminal plate 310. The positive electrode terminal block 320 may contain, for example, Fe or the like. The positive electrode terminal block 320 is bonded to the upper surface of the top wall 222. A positive electrode terminal plate 310 is bonded to the upper surface of the positive electrode terminal block 320.

The positive electrode coupling pin 420P may have, for example, a cylindrical outer shape. Through holes are formed in each of the positive electrode terminal plate 310 and the positive electrode terminal block 320. The positive electrode coupling pin 420P is inserted through the through hole. When the positive electrode coupling pin 420P is inserted into the connecting hole 412h, the lower end of the positive electrode coupling pin 420P is connected to the second flat plate portion 412. The upper end of the positive electrode coupling pin 420P may be fixed to the positive electrode terminal plate 310 by caulking, for example.

The negative electrode current collector plate 410N connects the plurality of negative electrode tabs 110N and the negative electrode coupling pin 420N. That is, the coupling member 400 electrically connects the electrode assembly 100 and the negative electrode terminal 300N. In the cell case 200, the negative electrode coupling pin 420N, the negative electrode current collector plate 410N, and the negative electrode tab 110N form a “second current path 22” (see FIG. 4).

The negative electrode coupling pin 420N connects the negative electrode current collector plate 410N and the negative electrode terminal plate 330. The negative electrode coupling pin 420N may have, for example, a cylindrical outer shape. When the negative electrode coupling pin 420N is inserted into the connecting hole 412h, the lower end of the negative electrode coupling pin 420N is connected to the second flat plate portion 412. The upper end of the negative electrode coupling pin 420N may be fixed to the negative electrode terminal plate 330 by caulking, for example.

### 5. FUSE PORTION

At least one of the first current path 21 (positive electrode side) and the second current path 22 (negative electrode side) includes a fuse portion. The first current path 21 may include a first fuse portion. The second current path 22 may include a second fuse portion. When an overcurrent flows in the circuit in the cell case 200, at least one of the first fuse portion and the second fuse portion may be disconnected. Both the first fuse portion and the second fuse portion may be disconnected. Either the first fuse portion or the second fuse portion may be disconnected.

The fuse portion in the present embodiment is not limited to a fuse portion that fuses (melts). The fuse portion may be physically disconnected while the fuse portion does not melt. For example, at least one of the first current path 21 and the second current path may be disconnected by an external force from the thermal expansion member 11 (described later), the self-weight of the electrode assembly 100, or the like. In the first current path 21 and the second current path 22, when the temperature rises, a portion to be disconnected is regarded as a fuse portion. For example, external force from the thermal expansion member 11, the self-weight of the electrode assembly 100, or the like may promote melting of the fuse portion.

For example, the current collector plate 410 may include a fuse portion. The current collector plate 410 may include, for example, a first flat plate portion 411, a connection portion 413, and a second flat plate portion 412. The connection portion 413 may be disposed between the first flat plate portion 411 and the second flat plate portion 412. The connection portion 413 may connect the first flat plate portion 411 and the second flat plate portion 412. The connection portion 413, the first flat plate portion 411, and the second flat plate portion 412 may all have the same material or different materials. The connection portion 413 includes a fusible material. The connection portion 413 may be made of a fusible material. The connection portion 413 may comprise any fusible material. The connection portion 413 may include, for example, a metal material. The connection portion 413 may have a smaller cross-sectional area than, for example, the first flat plate portion 411 and the second flat plate portion 412. Here, the cross-sectional area indicates an area of a cross section orthogonal to the current flow direction. Since the cross-sectional area is small, the resistance of the connection portion 413 can be increased in comparison with the other portions. Therefore, when an overcurrent flows through the current collector plate 410, it is expected that the connection portion 413 is selectively fused. That is, the connection portion 413 can function as a fuse portion. The portion having a small cross-sectional area may also be referred to as a thin-walled portion.

For example, a fuse portion may be provided in the electrode tab. For example, the electrode tab may be provided with a weakened portion. The weakened portion may include, for example, a notch or the like. In the notch, the cross-sectional area of the electrode tab may be locally reduced. When an overcurrent flows through the electrode tab, the notch portion may function as a fuse portion. The weakened portion may include, for example, a fold line, a perforation line, or the like.

For example, a weakened portion may be provided at a joining portion between the electrode tab and the current collector plate 410. For example, a weakened portion may be provided at a joining portion between the current collector plate 410 and the coupling pin 420. For example, the joining portion may include a portion where the joining strength (weld strength) is locally weak.

### 6. THERMAL EXPANSION MEMBER

FIG. 4 is a conceptual diagram showing an example of arrangement of thermal expansion members in the present embodiment. The power storage cell 1 may include a thermal expansion member 11. The power storage cell 1 may include a plurality of thermal expansion members 11. The thermal expansion member 11 is disposed between the top wall 222 and the electrode assembly 100. For example, the top wall 222 may hold the thermal expansion member 11. For example, a thermal expansion member may be attached to at least one of the top wall 222 and the electrode assembly 100. The top wall 222 and the electrode assembly 100 may sandwich the thermal expansion member 11. When the temperature in the cell case 200 rises, the thermal expansion member 11 expands. Arrows in FIG. 4 indicate expansion directions of the thermal expansion member 11. For example, the volume of the thermal expansion member 11 may expand to 2 to 10 times (or 2 to 5 times). The expanded thermal expansion member 11 can press the electrode assembly 100 in the Z-axis direction. Expansion of the thermal expansion member 11 may increase the distance between the electrode terminal 300 and the electrode assembly 100. Expansion of the thermal expansion member 11 may promote disconnection of the fuse portion. Further, it is expected that the expanded thermal expansion member 11 restrains the electrode assembly 100 to inhibit the recombination of the fuse portion.

In the X-axis direction, the thermal expansion member 11 may be positioned, for example, intermediate between the positive electrode terminal 300P and the negative electrode terminal 300N. The thermal expansion member 11 may be positioned closer to the positive electrode terminal 300P than the middle. By positioning the thermal expansion member 11 closer to the positive electrode terminal 300P, the disconnection of the fuse portion in the first current path 21 (positive electrode side) can be promoted. The thermal expansion member 11 may be positioned closer to the negative electrode terminal 300N than the middle. By positioning the thermal expansion member 11 closer to the negative electrode terminal 300N, the disconnection of the fuse portion in the second current path 22 (negative electrode side) can be promoted.

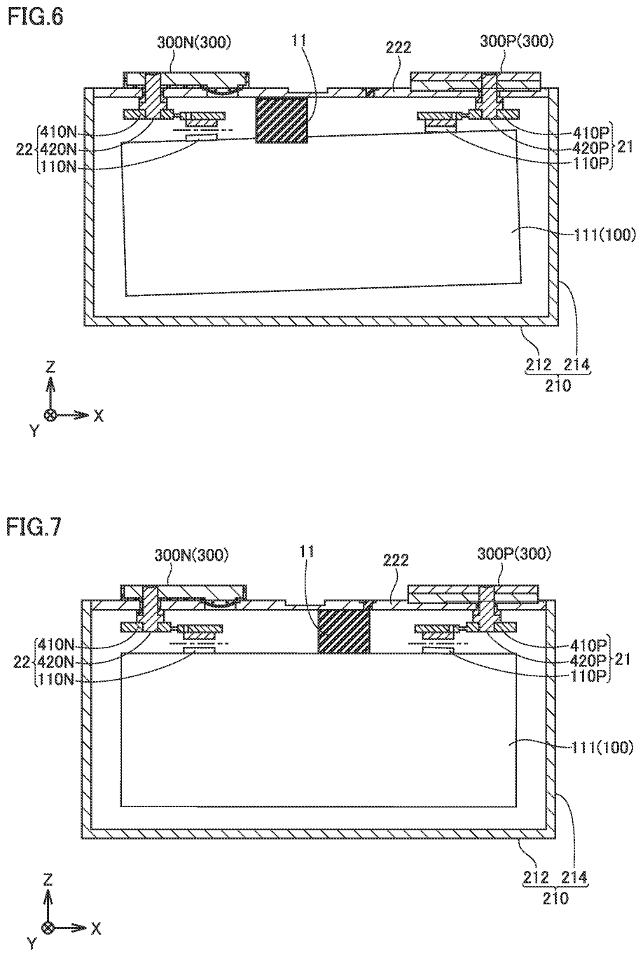

FIG. 5 is a conceptual diagram showing a first disconnection example of a fuse portion. FIG. 6 is a conceptual diagram showing a second disconnection example of the fuse portion. FIG. 7 is a conceptual diagram showing a third disconnection example of the fuse portion. The one-dot chain line in FIGS. 5 to 7 shows an example of the disconnection position. For example, either the first current path 21 or the second current path 22 may be disconnected (see FIGS. 5 and 6). For example, both the first current path 21 and the second current path 22 may be disconnected (see FIG. 7). Both the first current path 21 and the second current path 22 may be disconnected simultaneously, or the first current path 21 and the second current path 22 may be disconnected sequentially. When the first current path 21 and the second current path 22 are sequentially disconnected, the disconnection order is arbitrary.

The thermal expansion member 11 may have, for example, an insulating property. The thermal expansion member 11 may include, for example, a thermally expandable rubber, a thermally expandable capsule, or the like. The expansion start temperature of the thermal expansion member 11 may be lower than or higher than the melting point of the fuse portion.

### 7. THERMAL CONTRACTION MEMBER

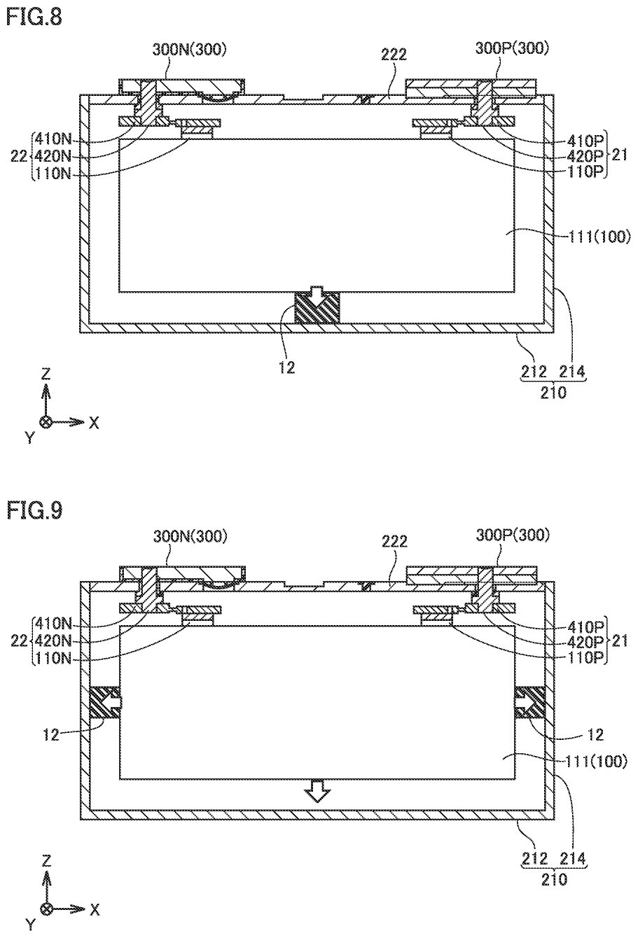

FIG. 8 is a conceptual diagram showing a first arrangement example of the thermal contraction member in the present embodiment. The power storage cell 1 may include a thermal contraction member 12. The power storage cell 1 may include a plurality of thermal contraction members 12. The thermal contraction member 12 may be disposed, for example, between the bottom wall 212 and the electrode assembly 100. The thermal contraction member 12 supports the electrode assembly 100. When the temperature in the cell case 200 rises, the thermal contraction member 12 contracts. For example, the volume of the thermal contraction member 12 may be reduced to 0.5 to 0.1 times. The contraction of the thermal contraction member 12 causes the electrode assembly 100 to lose its support from the thermal contraction member 12. It is expected that a part of the self-weight of the electrode assembly 100 is distributed to the fuse portion to promote disconnection of the fuse portion. Further, it is expected that the recombination of the fuse portion is inhibited by restraining the electrode assembly 100 by the self-weight of the electrode assembly 100.

For example, when the electrode assembly 100 is suspended from the top wall 222, disconnection of the fuse portion may be further facilitated. Arrows in FIG. 8 indicate the contraction direction of the thermal contraction member 12 and the direction of the self-weight of the electrode assembly 100. As in the case of the thermal expansion member 11 (FIGS. 5 to 7), either or both of the first current path 21 and the second current path 22 may be disconnected.

FIG. 9 is a conceptual diagram showing a second arrangement example of the thermal contraction member in the present embodiment. The thermal contraction member 12 may be disposed, for example, between the peripheral wall 214 and the electrode assembly 100. The thermal contraction member 12 supports the electrode assembly 100. The thermal contraction member 12 may be supported by the peripheral wall 214. The contraction of the thermal contraction member 12 causes the electrode assembly 100 to lose its support from the thermal contraction member 12. It is expected that a part of the weight of the electrode assembly 100 is distributed to the fuse portion to promote disconnection of the fuse portion. Arrows in FIG. 9 indicate the contraction direction of the thermal contraction member 12 and the direction of the self-weight of the electrode assembly 100.

The thermal contraction member 12 may have an insulating property. The thermal contraction member 12 may include, for example, a heat shrinkable rubber or the like. The thermal contraction member 12 may be, for example, a hollow body. The thermal contraction member 12 may include, for example, a thermoplastic resin. The thermal contraction member 12 may shrink by melting the thermoplastic resin (outer shell). The contraction starting temperature of the thermal contraction member 12 may be lower than or higher than the melting point of the fuse portion.

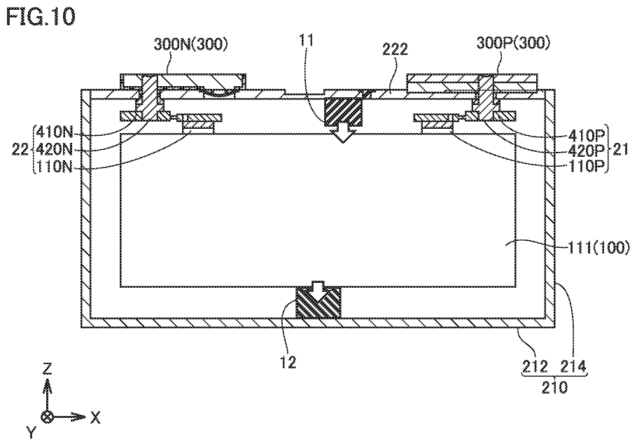

FIG. 10 is a conceptual diagram showing an example of arrangement of a thermal expansion member and a thermal contraction member in the present embodiment. The power storage cell 1 may include both the thermal expansion member 11 and the thermal contraction member 12. The synergistic action of the thermal expansion member 11 and the thermal contraction member 12 is expected to further inhibit the recombination of the fuse portion. The expansion start temperature of the thermal expansion member 11 may be the same as or different from the contraction start temperature of the thermal contraction member 12. For example, the contraction start temperature of the thermal contraction member 12 may be lower than the expansion start temperature of the thermal expansion member 11.

### 8. OTHER CONFIGURATIONS

The power storage cell 1 may include an insulator 500. The insulator 500 insulates the coupling member 400 from the cell case 200. Insulator 500 includes an insulating sheet 510 and an insulating gasket 520.

The insulating sheet 510 is connected to the lower surface of the top wall 222. In the height direction of the insulating sheet 510, a through hole is formed in a portion overlapping with the pressure release valve 222a, a portion overlapping with the liquid injection hole 222b, a portion overlapping with each through hole 222d, and a portion overlapping with the inversion plate 224.

The insulating gasket 520 has a shape surrounding the coupling pin 420. The insulating gasket 520 insulates the coupling pin 420 from the cell case 200. The insulating gasket 520 includes a positive electrode gasket 520P and a negative electrode gasket 520N.

The positive electrode gasket 520P covers the positive electrode coupling pin 420P. The positive electrode gasket 520P has a cylindrical outer shape. The negative electrode gasket 520N covers the negative electrode coupling pin 420N. The negative electrode gasket 520N may have the same structure as the positive electrode gasket 520P. The negative electrode gasket 520N (insulating member) electrically insulates the top wall 222 from the negative electrode terminal 300N.

The negative electrode terminal 300N includes a negative electrode terminal plate 330 and a negative electrode coupling pin 420N. The negative electrode terminal plate 330 may be made of metal, for example. The negative electrode terminal plate 330 may include, for example, copper (Cu), nickel (Ni), or the like. The insulating member 340 electrically insulates the negative electrode terminal 300N from the top wall 222. The insulating member 340 may be made of, for example, a resin material. The inversion plate 224 may have, for example, a dish-shaped or bowl-shaped outer shape. When the internal pressure of the cell case 200 increases, the inversion plate 224 may be inverted. When the inversion plate 224 is inverted, the top wall 222 and the negative electrode terminal 300N may be electrically connected to each other.

### 9. APPENDIX

Instead of the thermal contraction member 12, a thermoplastic member (solid body) may be used. That is, the thermoplastic material may support the electrode assembly 100. The thermoplastic member may melt due to an increase in temperature. The power storage cell 1 may be configured such that the electrode assembly 100 loses its support by melting the thermoplastic material.

What is claimed is:

1. A power storage cell comprising:
a cell case; and
an electrode assembly, wherein
the cell case houses the electrode assembly,
the cell case includes a top wall, a peripheral wall, and a bottom wall,
the top wall faces the bottom wall,
the peripheral wall connects the top wall and the bottom wall,
the top wall is provided with an electrode terminal,
a current path that electrically connects the electrode terminal and the electrode assembly is formed in the cell case, and
the current path includes a fuse portion,
the power storage cell further comprising at least one of a thermal expansion member and a thermal contraction member, wherein
the thermal expansion member is disposed between the top wall and the electrode assembly, and
the thermal contraction member is disposed between the electrode assembly and at least one of the peripheral wall and the bottom wall, and supports the electrode assembly.

2. The power storage cell according to claim 1, wherein the power storage cell is configured such that at least one of expansion of the thermal expansion member and contraction of the thermal contraction member increases a distance between the top wall and the electrode assembly.

3. The power storage cell according to claim 1, wherein the electrode assembly is suspended from the top wall.

4. The power storage cell according to claim 1, wherein
the electrode assembly includes an electrode tab, and
the electrode tab is provided with the fuse portion.

5. The power storage cell according to claim 1, comprising both the thermal expansion member and the thermal contraction member.
